(19) United States
(12) Patent Application Publication
(10) Pub. No.: US 2007/0035156 A1
(43) Pub. Date: Feb. 15, 2007

(54) Combined pinch/temperature sensor for a power liftgate

(76) Inventors: Gene Compton, Clinton Township, MI (US); Dave Swanson, Dearborn, MI (US); Michael George, Farmington Hills, MI (US); James L. Carlson, Madison Heights, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/202,793

(22) Filed: Aug. 12, 2005

(51) Int. Cl. B60J 5/00

(52) U.S. Cl. 296/146.7

(57) ABSTRACT

A combination pinch/temperature sensor for a closure member of a motor vehicle includes a first and second pinch sensing element coupled thereto. The first pinch sensing element is coupled to one of the left side and right side of the closure member for sensing a pinch condition on the corresponding side of the closure member and generating a corresponding pinch signal. The second pinch sensing element is in electrical communication with the first pinch sensing element and is coupled to the other one of the left side and right side of the closure member for sensing a pinch condition on the other side of the closure member and generating a corresponding pinch signal. Furthermore, one of the first and second pinch sensing elements also senses an ambient temperature outside the motor vehicle and generates an ambient temperature signal for use in controlling the closure member in extreme ambient temperature conditions.

### FIELD OF THE INVENTION

The present invention generally relates to power liftgates of motor vehicles. More particularly, the present invention pertains to a combined pinch and temperature sensor for a motor vehicle power liftgate.

### BACKGROUND OF THE INVENTION

In motor vehicles such as minivans, sport utility vehicles and the like, it has become common practice to provide the vehicle body with a large rear opening. A liftgate (also referred to as a tailgate) is typically mounted to the vehicle body with hinges for pivotal movement about a transversely extending axis between an open position and a closed position. The liftgate is operated either manually or electronically via a power drive mechanism including a reversible electric motor. For example, such arrangements are shown in commonly assigned U.S. Pat. Nos. 5,531,498; 5,563,483; and 5,448,856.

There are instances, however, when it is desirable to disable the power drive mechanism associated with the liftgate. For example, during power operation of a vehicle liftgate, the liftgate may unexpectedly encounter an obstacle in its path. It is therefore desirable to cease its powered movement in that event to prevent damage to the obstacle and/or the liftgate and its power drive mechanism. U.S. Pat. No. 6,297,605 discloses a powered liftgate system having a pinch sensor for causing the liftgate movement to stop upon sensing an encounter with an obstacle. This pinch sensor, however, has diagnostic limitations since if there is a failure in the pinch sensor, it is not possible to determine from which side of the liftgate the failure is located.

Another condition in which it may be desirable to disable the power drive mechanism of the liftgate is when extreme temperature conditions are present that would affect the proper operation of the liftgate. For example, the resistance in operating the power actuator may be too great in extreme hot temperatures and not enough in extreme cold temperatures. Temperature sensors have been used to disable the power actuator under these circumstances.

Although pinch and temperature sensors are available to disable movement of the liftgate under undesirable conditions, these sensors are typically packaged separately within the vehicle with an expense associated with each sensor. It is, thus, desirable to have just one sensor that is capable of sensing both obstructions and extreme temperature conditions in a cost effective manner and of providing superior diagnostic capability.

### SUMMARY OF THE INVENTION

Accordingly, it is a general object of the present invention to provide an improved sensing arrangement for a powered liftgate system for a motor vehicle.

It is an object of the present invention to provide a pinch sensing arrangement that has improved diagnostic capability by distinguishing between left and right sides of the pinch sensor having a failure.

It is yet another object of the present invention to provide a combination pinch/temperature sensor that can sense both a pinch condition and an extreme temperature condition while eliminating unnecessary circuitry.

In one form, the present invention provides a combination pinch/temperature sensor for a closure member of a motor vehicle having a first pinch sensing element for sensing a pinch condition on one of a left and right side of the closure member and for generating a corresponding pinch signal. The sensor also includes a second pinch sensing element in electrical communication with the first pinch sensing element for sensing a pinch condition on the other one of the left and right sides of the closure member and for generating a corresponding pinch signal. One of the first and second pinch sensing elements also senses an ambient temperature outside the motor vehicle and generates a corresponding ambient temperature signal.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a rear perspective view of an exemplary motor vehicle incorporating a combined pinch/temperature sensor for a power liftgate of a motor vehicle constructed in accordance with the teachings of a preferred embodiment of the present invention;

FIG. 2 is a view of a portion of an inner side the liftgate of FIG. 1 with portions removed for further illustration of the pinch sensing arrangement of the present invention;

FIG. 3 is a schematic diagram of a prior art pinch and temperature sensing arrangement; and

FIG. 4 is a schematic diagram of the combined pinch/temperature sensor of the present invention.

### DETAILED DESCRIPTION OF THE PREFERRED EMBODIMENTS

The following description of the preferred embodiment(s) is merely exemplary in nature and is in no way intended to limit the invention, its application, or uses.

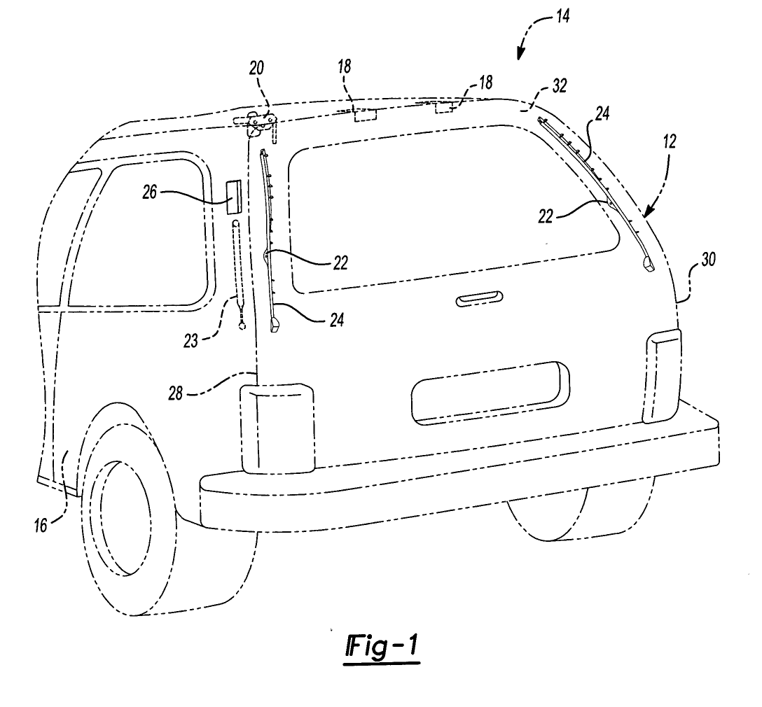

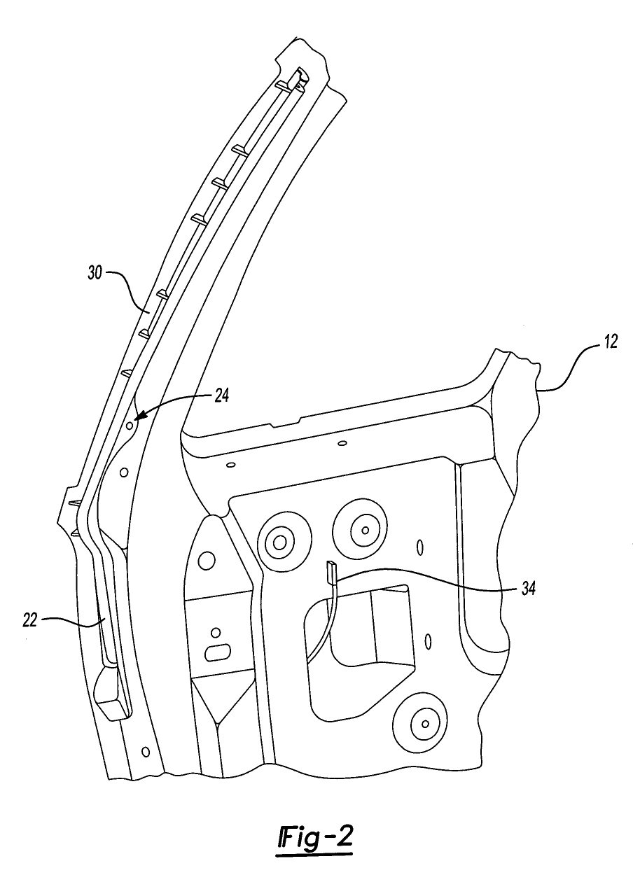

With initial reference to FIGS. 1 through 2, a combined pinch/temperature sensor constructed in accordance with the present invention is generally identified with reference numeral 22. The sensor 22 is shown operatively associated with a closure panel 12 of a motor vehicle 14. In the embodiment illustrated, the closure panel is a liftgate 12. It is to be understood by those skilled in the art that the particular use of the teachings of the present invention shown throughout the drawings is merely exemplary.

The liftgate 12 is mounted to a body 16 of the motor vehicle 14 through a pair of hinges 18 to pivot about a transversely extending pivot axis with respect to a large opening in the rear of the body 16. The liftgate 12 is mounted to articulate about its hinge axis between a closed position where it closes the opening and an open position where it completely uncovers the opening for free access to the vehicle body interior and assumes a slightly upwardly angled position above horizontal. The liftgate 12 is secured in its closed position by a latching mechanism (not shown). The liftgate 12 is opened and closed by a drive mechanism 20 with the assist of a pair of gas springs (one of which is identified at reference numeral 23) connected between the liftgate 12 and the body 16. Insofar as the present invention is concerned, the drive mechanism 20 is conventional.

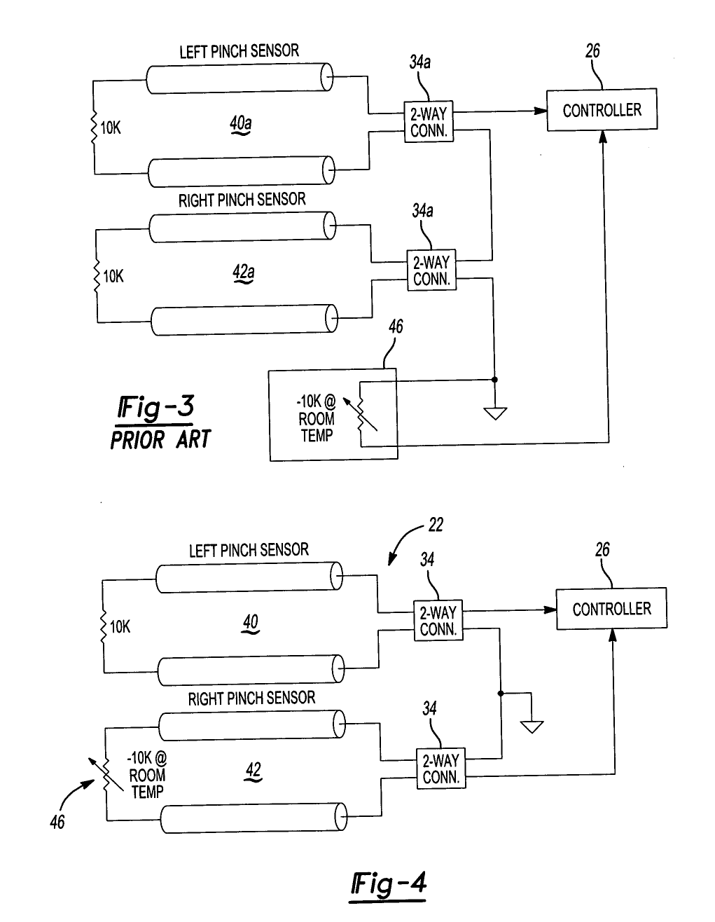

In the exemplary embodiment illustrated, the sensor 22 is shown to include a left pinch sensing element 40 and a right pinch sensing element 42 (FIG. 4) positioned proximate to laterally opposing sides 28 and 30 of the liftgate 12. Both of the sensing elements 40, 42 include an upper end in close proximity to an upper lateral edge 32 of the liftgate 12. The sensing elements 40, 42 extend downwardly from their upper ends along a substantial portion of the liftgate 12. The sensing elements 40, 42 are both electrically attached to a wire harness 34 adapted to plug into a controller 26. In a conventional manner, the controller 26 controls the drive mechanism 20 to open the liftgate 12 in the event it receives an electrical signal from one of the sensing elements 40, 42.

In the exemplary embodiment illustrated, each of the sensing elements 40, 42 is mounted to the liftgate 12 through a mounting track 24. The mounting tracks 24 are substantial mirror images of one another. For this reason, only one of the mounting tracks 24 needs to be described herein. The mounting track 24 provides a mounting surface for the sensing elements 40, 42 which can deflect after the sensing elements 40, 42 compress and send the electrical signal to the controller 26. This deflection allows the controller 26 sufficient time to reverse the drive mechanism 20 without damaging the obstruction, the liftgate 12 or the drive mechanism 20. The mounting track 24 also provides a gradually changing surface to which the sensing elements 40, 42 can be mounted. In the exemplary embodiment, the sensing elements 40, 42 are mounted to the mounting tracks 24, which are in turn attached to the liftgate 12. Alternatively, it will be understood that in certain applications it may be desirable to mount the sensing elements 40, 42 and their associated tracks 24 to the body 16 of the motor vehicle 14 adjacent the closure member 12.

In addition to responding to a pinch condition, the sensor 22 of the present invention monitors the outside ambient temperature for extreme temperature conditions that would affect the proper operation of the powered liftgate 12. For example, the resistance in operating the gas springs 23 may be too great in extreme hot temperatures, such as 150 degrees F. or higher, and not enough in extreme cold temperatures, such as −22 degrees or lower. Thus, in hot temperature, the controller 26 may recognize this added force to close the liftgate 12 as a false obstacle and continuously reverse itself. Thus, the controller 26 disables the drive mechanism 20 when an extreme hot temperature is exceeded. In cold temperatures, the gas springs 23 may have trouble holding the liftgate 12 open in which case the driver should lift the liftgate 12 manually. Again, the controller 26 in this instance disables the drive mechanism 20 when the ambient temperature is less than an extreme cold temperature. The sensor 22 of the present invention provides this monitoring feature as well, as will be described in more detail below.

Turning now to FIG. 3, there is shown a schematic diagram of a prior art sensing arrangement for sensing both a pinch condition and an extreme temperature condition. In the prior art sensor, the left pinch sensor element 40a and the right pinch sensor element 42a were connected together in series via two-way connectors 34a, with one output coupled to controller 26 and the other output coupled to ground. With this circuit, a pinch condition was detected if a short to ground failure occurred. However, it is not possible to tell which pinch sensing element 40a, 42a was faulty or experiencing the pinch condition.

Furthermore, a thermistor 46 was typically available separate from the pinch sensor in which one output was coupled to ground and the other to the controller 26. An extreme temperature condition was detected if the resistance either exceeded or fell below predetermined thresholds.

Turning now to FIG. 4, there is shown the sensor 22 of the present invention in which both pinch and extreme temperature conditions can be detected by the same circuit. The sensor 22 includes the left pinch sensing element 40 having one output coupled to controller 26 and the other output coupled to ground via two-way connector 34. Sensor 22 also includes the right pinch sensing element 42 having one output coupled to controller 26 and the other output coupled to ground via two-way connector 34. However, right pinch sensing element 42 also has the thermistor 46 coupled in line thereto, the thermistor being responsive to ambient temperature.

The sensing elements 40, 42 are preferably elongated structures having a pair of contacts (not shown) extending along their length. The contacts are substantially encapsulated in an epdm rubber and are normally spaced apart. When the sensing elements 40, 42 are compressed in a direction substantially parallel to its length, the pair of contacts is closed so as to generate an electrical signal, such as a voltage signal. The normal voltage of the left pinch sensing element 40 when unpinched is a predetermined value, e.g., 2.5 Volts. So, an unpinched voltage range would be something like 1.5 V to 3.5 V. If the voltage is greater than the normal unpinched voltage maximum, then a left pinch condition is detected and the controller 26 causes drive mechanism 20 to reverse direction to articulate the liftgate 12 to its open position. For diagnostic purposes, a Left Pinch High Diagnostic Trouble Code could be set for indicating an open circuit or short to battery condition at the left pinch sensing element 40.

If the voltage is within the unpinched voltage range, then no action is taken. However, if the voltage is below the unpinched voltage range, a left pinch is detected as described above. Again, for diagnostic purposes, a Left Pinch Low Diagnostic Trouble Code could be set for the left pinch sensing element 40 if this condition occurs for more than a predetermined amount of time since a too low condition could also be indicative of a pinch condition.

For the right pinch sensing element 42, the same logic and diagnostic capability is employed, however, the unpinched voltage range is modified to account for temperature effects. That is, when unpinched, the voltage on the thermistor 46 varies with temperature thereby resulting in a much larger range of unpinched voltages, e.g., 0.4 V to 4.8 V. Furthermore, since the ambient temperature is proportional to the voltage, the ambient temperature can be determined based on the voltage using a look-up table containing a predetermined correlation between temperature and voltage of the right pinch sensing element 42.

Thus, in operation, when the liftgate 12 encounters an obstacle proximate to the sensor 22 as it is articulated towards its closed position, the sensor 22 is compressed and the voltage exceeds a predetermined value, the controller 26 reverses the drive mechanism 20 to articulate the liftgate 12 to its open position. In addition, when the ambient temperature indicates an extreme temperature condition, the controller 26 disables the drive mechanism 20 until the extreme condition is no longer present.

The description of the invention is merely exemplary in nature and, thus, variations that do not depart from the gist of the invention are intended to be within the scope of the invention. Such variations are not to be regarded as a departure from the spirit and scope of the invention. For example, the thermistor 46 could be coupled in line with the left pinch sensing element 40 as opposed to the right pinch sensing element 42.

What is claimed is:

1. A combination pinch/temperature sensor for a closure member of a motor vehicle, the closure member having a left side and a right side and mounted for articulation relative to a body portion of the motor vehicle, the closure member driven by a drive mechanism between an open position and a closed position, the sensor comprising:
a first pinch sensing element coupled to one of the left side and right side of the closure member for sensing a pinch condition on the one of the left and right sides of the closure member and generating a corresponding pinch signal;
a second pinch sensing element in electrical communication with the first pinch sensing element and coupled to the other one of the left side and right side of the closure member for sensing a pinch condition on the other one of the left and right sides of the closure member and generating a corresponding pinch signal; and
wherein one of the first and second pinch sensing elements further for sensing an ambient temperature outside the motor vehicle and generating an ambient temperature signal.

2. The sensor as recited in claim 1 wherein each of the first and second pinch sensing elements are elongated structures having a pair of contacts spaced apart so that when either one of the first and second pinch sensing elements is compressed in a direction substantially parallel to their length, the pair of contacts associated with the either one of the first and second pinch sensing elements are closed and generate a corresponding electrical signal.

3. The sensor as recited in claim 1 wherein the one of the first and second pinch sensing elements generates an electrical signal that varies based on ambient temperature.

4. The sensor as recited in claim 3 wherein the one of the first and second pinch sensing elements includes a thermistor coupled thereto.

5. The sensor as recited in claim 2 wherein the electrical signal is a voltage signal.

6. The sensor as recited in claim 1 wherein the first pinch sensing element has a first and second output and wherein the second pinch sensing element has a third and fourth output, wherein the first output is provided for generating the pinch signal on one of the left and right side of the closure member, the fourth output is provided for generating the pinch signal on the other one of the left and right side of the closure member, and the second and third outputs are coupled to ground.

7. The sensor as recited in claim 1 further comprising:
a controller in electrical communication with the sensor for performing one of controlling the drive mechanism to reverse direction so as to immediately articulate the closure member to the open position and disabling automatic actuation of the drive mechanism based on the pinch and ambient temperature signals.

8. The sensor as recited in claim 7 wherein the ambient temperature signal includes an extreme hot temperature signal and an extreme cold temperature signal and wherein the controller disables automatic actuation of the drive mechanism upon receiving the extreme hot and cold temperature signals.

9. The sensor as recited in claim 8 wherein the extreme cold temperature signal includes an ambient temperature less than −22 degrees Fahrenheit.

10. The sensor as recited in claim 8 wherein the extreme hot temperature signal includes an ambient temperature greater than 150 degrees Fahrenheit.

11. A motor vehicle comprising:
a body;
a closure member mounted to the body for articulation about a laterally extending pivot axis between an open position and a closed position, the closure member having a left side and a right side;
a drive mechanism for driving said closure member between said open position and said closed position;
a pinch sensor coupled to said closure member, said sensor comprising a first pinch sensing element coupled to one of the left side and right side of the closure member for sensing a pinch condition on the one of the left and right sides of the closure member and generating a corresponding pinch signal, a second pinch sensing element in electrical communication with the first pinch sensing element and coupled to the other one of the left side and right side of the closure member for sensing a pinch condition on the other one of the left and right sides of the closure member and generating a corresponding pinch signal, and wherein one of the first and second pinch sensing elements is further provided for sensing an ambient temperature outside the motor vehicle and generating an ambient temperature signal; and
a control module in electrical communication with said sensor, said control module for controlling said drive mechanism to articulate the closure member to the open position and for automatically disabling the drive mechanism based on the pinch signal and the ambient temperature signal.

12. The motor vehicle of claim 11, wherein each of the first and second pinch sensing elements are elongated structures having a pair of contacts spaced apart so that when either one of the first and second pinch sensing elements is compressed in a direction substantially parallel to their length, the pair of contacts associated with the either one of the first and second pinch sensing elements are closed and generate a corresponding electrical signal.

13. The motor vehicle of claim 11, wherein the one of the first and second pinch sensing elements generates an electrical signal that varies based on ambient temperature.

14. The motor vehicle of claim 13, wherein the one of the first and second pinch sensing elements includes a thermistor coupled thereto.

15. The motor vehicle of claim 11, wherein the first pinch sensing element has a first and second output and wherein the second pinch sensing element has a third and fourth output, wherein the first output is provided for generating the pinch signal on one of the left and right side of the closure member, the fourth output is provided for generating the pinch signal on the other one of the left and right side of the closure member, and the second and third outputs are coupled to ground.

16. The motor vehicle of claim 11, wherein the ambient temperature signal includes an extreme hot temperature signal and an extreme cold temperature signal and wherein the controller disables automatic actuation of the drive mechanism upon receiving the extreme hot and cold temperature signals.
